(19) United States
(12) Patent Application Publication
(10) Pub. No.: US 2007/0270565 A1
(43) Pub. Date: Nov. 22, 2007

(54) New Catalysts for selective isocyanate dimerization

(75) Inventor: Jurgen Kocher, Langenfeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/803,639

(22) Filed: May 15, 2007

(30) Foreign Application Priority Data
May 18, 2006 (DE) 102006023262.3

(51) Int. Cl. C08G 18/00

(52) U.S. Cl. 528/44

(57) ABSTRACT

The present invention relates to the use of sulphonamide salts as dimerization catalysts for aliphatic isocyanates and also to a process for preparing dimeric isocyanates using the catalysts of the invention.

### CROSS-REFERENCE TO RELATED APPLICATIONS

The present application claims the right of priority under 35 U.S.C. § 119 (a)-(d) of German Patent Application Number 10 2006 023 262.3, filed May 18, 2006.

### BACKGROUND OF THE INVENTION

The present invention relates to the use of sulphonamide salts as dimerization catalysts for aliphatic diisocyanates such as hexamethylene 1,6-diisocyanate (HDD and also to a process for preparing dimeric isocyanates using the catalysts of the invention.

Because monomeric diisocyanates cannot be used as crosslinkers in polyurethane coating systems, due to their volatility and their toxicological properties higher molecular mass derivatives based for example on uretdione, isocyanurate, biuret, urethane or allophanate are generally used. A review of these polyisocyanates and of their preparation is given by way of example in J. Prakt. Chem./Chem. Ztg. 1994, 336, 185-200. Within the field of lightfast paints and coating compositions it is common to use polyisocyanates based on aliphatic and/or cycloaliphatic diisocyanates.

The oligomerization (typically dimerization or trimerization) of isocyanates to uretdiones, isocyanurates or iminooxadiazinediones is a known method for the modification of generally difunctional, low molecular mass C₁-C₃₀ isocyanates. Specifically for isocyanate dimerization, however, there have been few useful catalysts with high activity and selectivity that are suitable for use on the industrial scale.

A review of the industrially relevant dimerization processes and of the catalysts and catalyst systems employed in those processes is given in J. Prakt. Chem. 336 (1994) 185-200. Due to their inadequate catalytic activity and lack of selectivity with respect to dimer formation, particularly for industrial use, there is a need for new, improved systems.

EP-A 45 995 describes the use of special peralkylated aminophosphines as catalysts for the selective dimerization of isophorone diisocyanate (IPDI) (trimer fraction <2% by weight). A substantial disadvantage of these compounds, however, is their high sensitivity to oxidation to phosphoramides (e.g. hexamethylphosphoramide (HMPT)) which possess a high carcinogenic potential, which is prohibitive for broad industrial use.

EP-A 317 744 describes a process for preparing linear (cyclo)aliphatic uretdiones by catalysis with 4-dialkylaminopyridines, such as 4-dimethylaminopyridine (4-DMAP), for example. This process also yields linear IPDI uretdiones which are virtually free of isocyanurate groups. For the dimerization of hexamethylene 1,6-diisocyanate (HDI), however, 4-DMAP is not suitable.

A high catalytic activity is shown by the azolate anions described in WO 02/92658, with cycloaliphatic diisocyanates, in particular, being converted with a high selectivity into dimeric uretdiones. The selectivity of the dimerization of linear aliphatic diisocyanates, however, is likewise relatively low.

EP-A 1 422 223 and EP-A 1 533 301 disclose phosphines having P-bonded cycloalkyl substituents and bicycloalkyl substituents, respectively. The phosphines are distinguished by a high dimerization selectivity.

DE-A 1 0336 184 describes sulphonamide salts with a 4-pyridyl radical which exhibit a very high dimerization selectivity in particular for cycloaliphatic diisocyanates. One disadvantage of these products is that the uretdione selectivity of these products for linear-aliphatic diisocyanates such as hexamethylene 1,6-diisocyanate (HDI), is relatively low (normally <90%) and the synthesis of the sulphonamide precursors proceeds only with poor yields.

It is an object of the present invention, therefore, to provide new catalysts for dimerizing linear aliphatic diisocyanates, said catalysts being readily accessible and being distinguished by improved selectivity with respect to uretdione formation.

It has now been found that the underlying object has now been solved, starting from compounds in accordance with DE-A 1 0336 184, by specific substitution on the sulphur.

### SUMMARY OF THE INVENTION

The present invention accordingly provides for the use of sulphonamide salts of the formula (I)

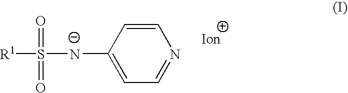

where

### R¹ is a perfluorinated alkyl radical and

### Ion⁽⁺⁾ is an organic or inorganic cation

in the uretdione formation of aliphatic isocyanates.

The invention further provides a process for dimerizing aliphatic isocyanates by reacting one or more aliphatic isocyanates in the presence of one or more sulphonamide salts of the formula (I)

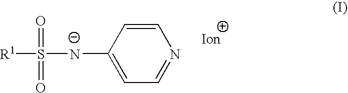

where

### R¹ is a perfluorinated alkyl radical and

### Ion⁽⁺⁾ is an inorganic or organic cation.

In formula (I) R¹ is preferably a CF₃ or a C₄F₉ group. With particular preference R¹ is =—CF₃.

In formula (I) Ion⁽⁺⁾ is preferably an alkali metal cation such as Li⁺, Na⁺ and K⁺, an alkaline earth metal cation such as Mg²⁺ and Ca²⁺ or an ammonium or phosphonium ion of the general formula (III)

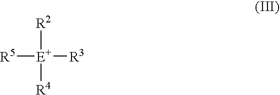

where
E is nitrogen or phosphorus,
R², R³ and R⁴ independently of one another are hydrogen or identical or different, optionally unsaturated and/or substitutent-carrying aliphatic or cycloaliphatic radicals having up to 24 carbon atoms and optionally up to 3 heteroatoms from the group consisting of oxygen, sulphur and nitrogen, and
R⁵ conforms to the definition of the radicals R², R³ and R⁴ or is a radical of the formula (IV)

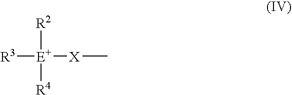

where
X is a divalent, optionally substituted aliphatic, cycloaliphatic, araliphatic or aromatic C₁-C₁₂ radical and
R², R³, R⁴ and E are as defined above.

With particular preference Ion⁽⁺⁾ is an alkali metal cation or a monovalent ammonium or phosphonium cation of the general formula (III) in which
E is nitrogen or phosphorus and
R², R³, R⁴ and R⁵ independently of one another are a saturated aliphatic or cycloaliphatic or optionally substituted aromatic or araliphatic radical having up to 18 carbon atoms.

Aliphatic isocyanates which can be used are all of the compounds of this kind that are known to the skilled person, it being immaterial whether they are used individually or in any desired mixtures with one another. Preferably these aliphatic isocyanates have 2 to 4, more preferably 2 or 3, free NCO groups.

Preferred aliphatic isocyanates of the aforementioned kind are linear-aliphatic isocyanates. With particular preference hexamethylene diisocyanate is used as aliphatic isocyanate in the process of the invention.

Typically in the process of the invention the sulphonamide salts of formula (I) are used in amounts of 0.001% to 10% by weight, preferably 0.005% to 7% by weight, more preferably 0.01% to 5% by weight, based on the amount of isocyanate used.

To catalyse the dimerization it is preferred to use exclusively sulphonamide salts of the formula (I).

The sulphonamide salts can be used in undissolved form, as a solid, or in the form of a solution in the process of the invention. In the case of a solution, the solvent should be chosen such that, although it does dissolve the catalyst with molecular or ionic dissociation, the composition and/or molecular structure of the sulphonamide anion or anions is or are not altered as a result of chemical reactions. At the same time the solvent either must be inert towards NCO functions or must react with isocyanates only with formation of urea, biuret, urethane or allophanate groups.

Where the sulphonamide salts are used in the form of a solution, preference is given to straight-chain or branched alcohols having an average OH functionality >1 and 1 to 20, preferably 1 to 10 carbon atoms such as methanol, ethanol, 1- and 2-propanol, the isomeric butanols, 2-ethylhexanol, 2-ethylhexane-1,3-diol, 1,3- and 1,4-butanediol or 1-methoxy-2-propanol.

Preference is given to their use in solution form.

In the process of the invention it is also possible to use solvents, though it is preferred to use no solvents other than the optionally-used catalyst solvent.

The process of the invention is carried out at temperatures of 60 to 120° C., preferably at temperatures of 70 to 100° C.

It will be appreciated that, if necessary, the process can also be carried out under increased or reduced pressure.

The process of the invention can be operated either continuously or discontinuously. A continuous process is understood, for example, to comprise preparation in a tube reactor or with the aid of tank cascades, while discontinous processes are, for example, processes in a tank (batch processes) or a flask.

In one preferred embodiment of the invention, the NCO oligomerization is taken to a conversion of 10-60 mol %, based on the total amount of NCO groups originally present, the oligomerization reaction is terminated, and unreacted isocyanate is separated off by means, for example, of distillation, optionally under reduced pressure, the oligomerized isocyanate being obtained in the form of a resin.

For the termination of the oligomerization reaction, all of the techniques known to the skilled person (J. Prakt. Chem./Chem. Ztg. 1994, 336, 185-190) are suitable.

They include the removal of the catalyst by means, for example, of extraction or filtration, optionally with the assistance of an adsorptive support material, and the inactivation of the catalyst system by thermal treatment and/or by addition of acids or acid derivatives such as benzoyl chloride, phthaloyl chloride, phosphinous, phosphonous or phosphorous acid, phosphinic, phosphonic or phosphoric acid or the acidic esters of the abovementioned phosphorus-containing acids. Preferred stoppers are monoalkyl or dialkyl phosphates such as (di)butyl phosphate, (di)octyl phosphate or (di)trihexyl phosphate, sulphuric acid or its acidic esters or sulphonic acids, such as, preferably, methanesulphonic acid and p-toluenesulphonic acid.

The amount of the catalyst poison that is needed to stop the reaction is guided by the amount of active catalyst. Generally speaking, 50 to 150 mol % of stopper is used, based on the amount of catalyst originally employed; preference is given to using equimolar amounts of stopper in respect of the amount of catalyst used. To deactivate the catalyst, the reaction mixture is heated at 80 to 100° C. for 2 h following the addition of the acidic stopper.

The polyisocyanates obtained for the process of the invention can be isolated and purified by known methods such as thin-film distillation, extraction, crystallization and/or molecular distillation. They are obtained as colourless or only slightly coloured liquids or solids.

Following removal of the monomeric, unreacted starting isocyanates, the sulphonamide salts essential to the invention lead to products having uretdione fractions of at least 95 mol %, based on the isocyanate derivatives formed in total.

Isocyanate derivatives, apart from the desired uretdione, are taken to include trimeric structures such as isocyanurate and iminooxadiazinedione, and also ureas, biurets, urethanes and allophanates.

The uretdiones obtainable in accordance with the invention are starting materials with diverse possible uses for the preparation of polymers, such as optionally foamed plastics or polyurethane paints, especially for preparing one- and two-component polyurethane paints, coating compositions, adhesives and adjuvants for application to materials such as wood, plastic, leather, metal, paper, concrete, masonry, ceramic and textile, for example.

### EXAMPLES

All percentages are by weight unless noted otherwise.

The NCO content of the resins described in the inventive and comparative examples was determined by titration in accordance with DIN 53 185.

The dynamic viscosities of the polyisocyanate resins were determined at 23° C. using the VT 550 viscometer with the PK 100 plate-cone measurement arrangement from Haake (Karlsruhe, Germany). Measurements at different shear rates ensure that the rheology of the inventive polyisocyanate mixtures described and also that of the comparison products corresponds to that of ideal Newtonian liquids. It is therefore unnecessary to state the shear rate.

The selectivity of the catalyst employed was determined by ¹³C NMR spectroscopy and by analysis of the possible structural types 1 to 4.

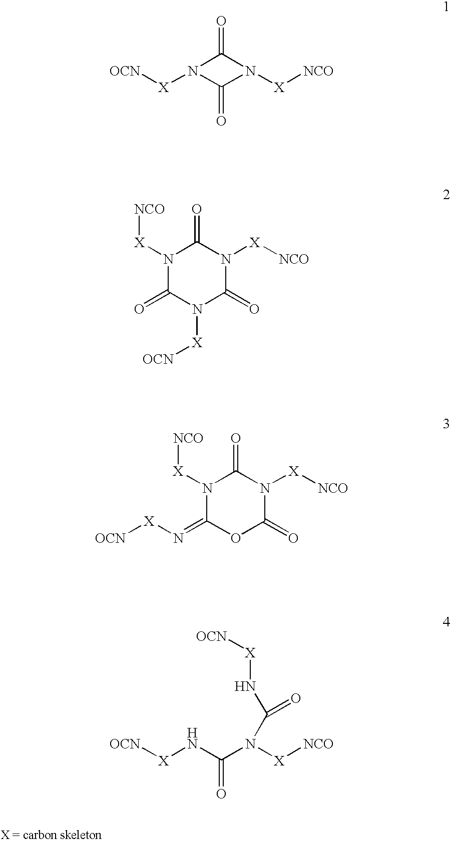

For this ¹³C NMR analysis, 0.5 ml of the respective reaction mixture was admixed with amounts of di-n-butyl phosphate that were stoichiometric with respect to the amounts of catalyst employed, this admixture being made in order to deactivate the catalyst and to prevent further reaction. Deuterated chloroform was added to set a concentration of approximately 50% by weight of resin. The measurements were made on a DPX 400 from Bruker, Karlsruhe, DE with a ¹³C resonance frequency of 100 MHz. As a reference for the ppm scale, tetramethylsilane was used as internal standard. Data for the chemical shift of the compounds I-4 in question were taken from the literature (cf. Die Angewandte Makromolekulare Chemie 1986, 141, 173-183 and references cited therein) or had been obtained by subjecting model substances to measurement.

### Example 1

### Preparation of trifluoromethyl-N-4-pyridylsulphonamide

13.0 g of 4-aminopyridine (0.138 mol), 19.1 ml of triethylamine (14.0 g, 0.138 mol) and 0.1 g of diazabicyclooctane (DABCO) were dissolved in 100 ml of dimethylformamide. Added dropwise to this solution at room temperature over the course of 15 minutes were 14.6 ml of trifluoromethanesulphonyl chloride (23.3 g, 0.138 mol). After the addition the temperature of the reaction mixture rose to 35° C. After the reaction mixture had been cooled to room temperature and stirred at this temperature for 17 h, the reaction mixture was discharged into 250 ml of water with stirring. The precipitated crude product was isolated by suction filtration and washed with three times 100 ml of water. Thereafter the crude product was dried at 100° C.

The dried crude product (18.9 g) was recrystallized from acetonitrile. This gave 14.5 g of clean product, whose structure was ascertained by mass spectrometry.

### Example 2

### Preparation of the Tetrabutylammonium Salt of the Sulphonamide of Example 1

A suspension of 5.2 g of the sulphonamide of Example 1 (23.2 mmol) in 13 ml of methanol was admixed at room temperature with 5.3 ml of a 30% strength by weight sodium methoxide solution in methanol (23.2 mmol). After 1 h of stirring at room temperature, 10.5 g of a 71.4% strength solution of tetrabutylammonium chloride in isopropanol (23.2 mmol) was added to the reaction mixture, which was stirred at room temperature for one hour further. The precipitated sodium chloride was filtered off with suction and the filtrate was concentrated to dryness by distillation. By addition three times of 10 ml in each case of methylene chloride, stirring of the catalyst in this solvent and distillative removal of the solvent, the catalyst was freed from residues of isopropanol. Drying at room temperature in vacuo gave 8.0 g of solid catalyst.

### Examples 3a

Inventive dimerization of hexamethylene 1,6-diisocyanate (HDI) with the catalyst of Example 2.

250 ml of hexamethylene 1,6-diisocyanate (260 g, 1.548 mol) were heated to 100° C. in a four-necked flask filled with dry nitrogen and carrying a reflux condenser. At the temperature of 100° C., 0.29 g of the catalyst of Example 2 (0.6 mmol) was added and the mixture was stirred at 100° C. for 7 h. The reaction mixture was subsequently adjusted to 80° C., admixed with 0.52 g of di-n-butyl phosphate (2.5 mmol) and stirred at 80° C. for 2 h. Then 242 g of the reaction mixture were worked up by means of a thin-film evaporator. The mixture was distilled at 120° C. under a pressure of 0.8 mbar to give 30.7 g of a uretdione-containing resin.

| | |
|---|---|
| Free NCO value of the resin: | 24.1% by weight |
| Viscosity of the resin: | 30 mPas |
| Composition of the resin: | 98 mol % uretdione (general formula 1), |
| | 2 mol % biuret (general formula 4) |

On the basis of the ¹³C NMR spectrum recorded the product was free from trimeric structures of the general formula 2 and 3. The desired uretdione of the structure of the general formula 1 is contaminated only slightly by biuret of the general formula 4, which forms as a result of traces of water being present.

### Examples 3b

Inventive dimerization of hexamethylene 1,6-diisocyanate (HDI) with the catalyst of Example 2.

300 ml of hexamethylene 1,6-diisocyanate (312 g, 1.548 mol) were heated to 100° C. in a four-necked flask filled with dry nitrogen and carrying a reflux condenser. At the temperature of 100° C., 0.35 g of the catalyst of Example 2 (0.6 mmol) was added in solution in 1 ml of n-butanol and the mixture was stirred at 100° C. for 4 h. The reaction mixture was subsequently admixed with 0.31 g of di-n-butyl phosphate (0.7 mmol) and stirred at 100° C. for 2 h. Then 298 g of the reaction mixture were worked up by means of a thin-film evaporator. The mixture was distilled at 120° C. under a pressure of 1.0 mbar to give 25.8 g of a uretdione-containing resin.

| | |
|---|---|
| Free NCO value of the resin: | 23.7% by weight |
| Viscosity of the resin: | 31 mPas |
| Composition of the resin: | 97 mol % uretdione (general formula 1), |
| | 3 mol % biuret (general formula 4) |

On the basis of the ¹³C NMR spectrum recorded the product was free from trimeric structures of the general formula 2 and 3. The desired uretdione of the structure of the general formula 1 is contaminated only slightly by biuret of the general formula 4, which forms as a result of traces of water being present.

### Example 4

### Preparation of Perfluorobutyl-N-4-pyridylsulphonamide

5.0 g of 4-aminopyridine (0.053 mol) were introduced in 52 ml of tetrahydrofuran as an initial charge at 50° C. At this temperature 7.4 ml of triethylamine (5.4 g, 0.053 mol) and 0.1 g of diazabicyclooctane (DABCO) were added to the reaction mixture. This solution was admixed dropwise at 50° C. over the course of 15 minutes with 9.5 ml of perfluorobutanesulphonyl fluoride (16.0 g, 0.053 mol). A slight exothermic reaction was observed. Stirring was continued at 55° C. for 11 h, after which the solvent was distilled off. The oil obtained was discharged into 200 ml of water with stirring. The precipitated crude product was isolated by filtration with suction.

The still slightly moist crude product (20.2 g) was recrystallized from acetonitrile. This gave 9.2 g of clean product, whose structure was ascertained by mass spectrometry.

### Example 5

### Preparation of the Tetrabutylammonium Salt of the Sulphonamide of Example 4

A suspension of 3.9 g of the sulphonamide of Example 1 (10.5 mmol) in 25 ml of methanol was admixed at room temperature with 2.0 ml of a 30% strength by weight sodium methoxide solution in methanol (10.5 mmol). After 1 h of stirring at room temperature, 4.7 g of a 61.4% strength solution of tetrabutylammonium chloride in isopropanol (10.5 mmol) was added to the reaction mixture, which was stirred at room temperature for one hour further. The precipitated sodium chloride was filtered off with suction and the filtrate was concentrated to dryness by distillation. This gave 4.6 g of catalyst of oily consistency.

### Examples 6

Inventive dimerization of hexamethylene 1,6-diisocyanate (HDI) with the catalyst of Example 5.

Under nitrogen, a glass vessel with septum was charged with 0.4 g of catalyst (0.6 mmol). 10 ml of hexamethylene 1,6-diisocyanate (10.4 g, 61.9 mmol) were added and the reaction solution was stirred at 80° C. for 22 h until its NCO value had dropped to 36.7% by weight. According to ¹³C NMR spectroscopy the reaction mixture, in terms of isocyanate derivatives, contained a mixture of 98 mol % of uretdione of structure 1 and 2 mol % of trimer of structure 2.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for dimerizing aliphatic isocyanates by reacting one or more aliphatic isocyanates in the presence of one or more sulphonamide salts of the formula (I) 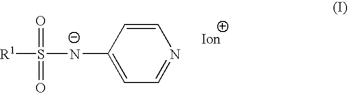
where
R¹ is a perfluorinated alkyl radical and Ion⁽⁺⁾ is an organic or inorganic cation.

2. Process according to claim 1, wherein R¹ is a CF₃ or a C₄F₉ group.

3. Process according to claim 1, wherein Ion⁽⁺⁾ is an alkali metal cation or a monovalent ammonium or phosphonium cation of the general formula (III) 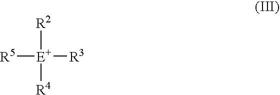
where
E is nitrogen or phosphorus and
R², R³, R⁴ and R⁵ independently of one another are a saturated aliphatic or cycloaliphatic or optionally substituted aromatic or araliphatic radical having up to 18 carbon atoms.

4. Process according to claim 1, wherein the aliphatic isocyanates used are linear-aliphatic isocyanates.

5. Process according to claim 4, wherein hexamethylene diisocyanate is used as one of the linear-aliphatic isocyanates.

6. Process according to claim 1, wherein the reaction is carried out at a temperature of 60 to 120° C. and to a conversion of 10 to 60 mol % of all NCO groups.

7. Process according to claim 1, further comprising terminating the reaction by addition of a catalyst poison, and distilling the resulting polyisocyanate to separate off unreacted monomeric isocyanate.

8. Polyisocyanate compositions obtained by a process according to claim 1.

9. Polyisocyanate compositions according to claim 8, wherein, as isocyanate derivatives, they contain at least 95 mol % of uretdione-containing compounds.

10. Substrates coated with coatings obtained using polyisocyanate compositions according to claim 8.
